(19) United States
(12) Patent Application Publication
(10) Pub. No.: US 2024/0246094 A1
(43) Pub. Date: Jul. 25, 2024

(54) MEDIA PROPELLING SYSTEMS AND METHODS THEREOF

(71) Applicant: Industrial Associates, LLC, Waukesha, WI (US)

(72) Inventors: John Porter, Mukwonago, WI (US); James P. Hausch, II, Milwaukee, WI (US)

(73) Assignee: Industrial Associates, LLC, Waukesha, WI (US)

(21) Appl. No.: 18/409,243

(22) Filed: Jan. 10, 2024

Related U.S. Application Data
(60) Provisional application No. 63/480,760, filed on Jan. 20, 2023.

(51) Int. Cl. B04B 11/02; B04B 9/04; B04B 9/10; F16K 3/32

(52) U.S. Cl. CPC B04B 11/02; B04B 9/04; B04B 9/10; F16K 3/32; B04B 9/06

(57) ABSTRACT

A media propelling system comprises a motor for rotating a wheel assembly that is configured to propel the media and a valve assembly configured to control flow rate of the media to the wheel assembly. The valve assembly includes a media valve configured to selectively open and close to control the flow rate of the media to the wheel assembly, an actuator that actuates the media valve to open or close the media valve and thereby change the flow rate of the media, and a control valve configured to receive pressurized material and dispense the pressurized material to the actuator to thereby control operation of the actuator. A control system is in communication with the motor and the control valve and is configured to control the control valve based on a comparison of a sensed or actual amperage of the motor and a target amperage of the motor.

### CROSS-REFERENCE TO RELATED APPLICATION

The present disclosure is based on and claims priority to U.S. Provisional Patent Application No. 63/480,760 filed Jan. 20, 2023, the disclosure of which is incorporated herein by reference.

### FIELD

The present disclosure relates to media propelling systems and more particularly to media propelling systems for controlling flow of media.

### BACKGROUND

Airless shot peening and airless shot blasting are two common shot propelling processes used to alter surface characteristics of metal parts. These media propelling process typically involve a rotating a wheel with vanes attached thereto at high speeds such that media, such as shot (small spheres), grit (angular pieces), or other abrasive media, that is introduced at or near the center of the wheel is accelerated and propelled by the vanes into contact with one or more surfaces of the part. The media impacts the surfaces and thereby textures, peens, smooths, and/or removes contaminants from the surface.

The following U.S. patents are incorporated herein by reference in entirety.
U.S. Pat. No. 6,981,910 discloses a throwing wheel assembly having a rotatable wheel and one or more throwing blades each removably positionable on the face of the wheel in a throwing position.
U.S. Pat. No. 10,155,299 discloses an impeller for a centrifugal blast wheel machine includes a hub provided at one end of the impeller, with the hub being configured to be coupled to the motor.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a media propelling system comprises a motor for rotating a wheel assembly that is configured to propel the media and a valve assembly configured to control flow rate of the media to the wheel assembly. The valve assembly includes a media valve configured to selectively open and close to control the flow rate of the media to the wheel assembly, an actuator that actuates the media valve to open or close the media valve and thereby change the flow rate of the media, and a control valve configured to receive pressurized material and dispense the pressurized material to the actuator to thereby control operation of the actuator. A control system is in communication with the motor and the control valve and is configured to control the control valve based on a comparison of a sensed or actual amperage of the motor and a target amperage of the motor.

In certain examples, a method of operating a media propelling system comprises operating a motor for rotating a wheel assembly that is configured to propel the media, providing a media valve that is configured to selectively opens or closes to thereby vary flow of the media to the wheel assembly, comparing, with a control system, sensed or actual amperage of the motor to a target amperage of the motor, and controlling, with the control system, pressure of pressurized material dispensed from a control valve to an actuator to thereby control operation of the actuator which opens or closes the media valve.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example media propelling system of the present disclosure.

FIG. 2 is a partial view of the system of FIG. 1 with a housing partially removed.

FIG. 3 is a schematic diagram of an example control system according to the present disclosure.

FIG. 4 is an example process flow according to the present disclosure.

FIG. 5 is a perspective view of another example media propelling system of the present disclosure.

### DETAILED DESCRIPTION

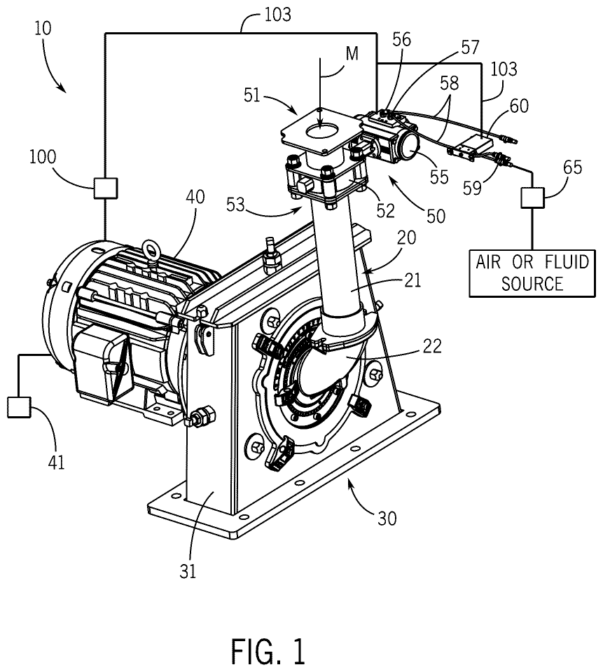

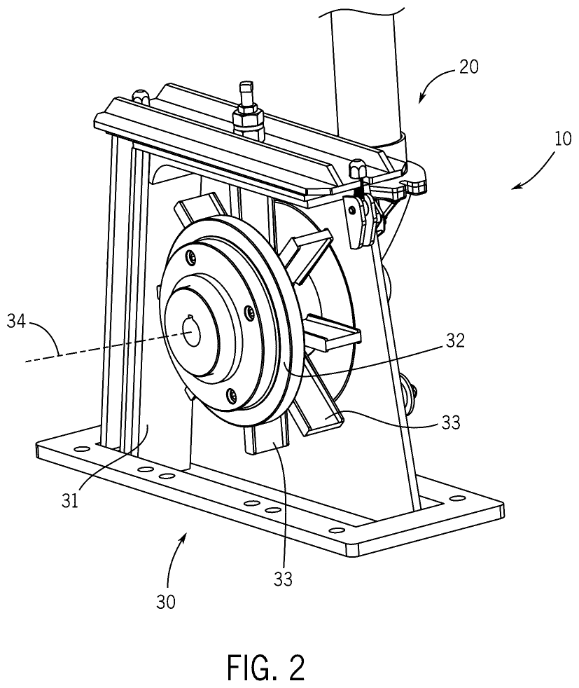

FIGS. 1-2 depict an example abrasive media propelling system 10 of the present disclosure. Note that while the systems and processes described hereinbelow for the media propelling system 10 are directed toward abrasive peening, the systems, and processes described hereinbelow can be utilized with and/or incorporated into other abrasive media propelling systems and processes such as shot blasting.

Through research and experimentation, the present inventors endeavored to develop the systems 10 of the present disclosure that are improvements over conventional systems known in the art. The systems 10 of the present disclosure advantageously increase the efficiency of the system and the motor by optimizing the flow of media through the system 10. The systems 10 are further configured to reduce and/or minimize conventional problems associated with the centrifugal abrasive propelling processes (e.g., shot peening or shot blasting process) and maintenance thereof. The present inventors also further endeavored to decrease the variation in flow rate of the media through the system, increase component and motor life, and reduce significant downtime events. Thus, the present inventors have developed the systems of the present disclosure.

The system 10 includes a feed assembly 20 having a tube 21 configured to receive media (see arrow M on FIG. 1) and a spout 22 configured to direct and dispense the media to a wheel assembly 30 (described further herein) of the system 10. The feed assembly 20 defines a pathway between and through the tube 21 and the spout 22 along which the media moves by gravity to the wheel assembly 30. Note that media can include but is not limited to abrasive or non-abrasive shot and grit that contact a surface of a target object (not depicted, e.g., metal part).

The wheel assembly 30 is configured to receive the media from the feed assembly 20 (as described above) and further propel the media at a target object (not depicted; e.g., plate, motor part) to thereby modify the target object. That is, wheel assembly 30 throws the media against the surface of the target object to impact the surface of the target object such that the media modifies (e.g., roughen, shape/curve, smooth, shot peen, induce compressive stress, harden, remove contaminants) the surface and/or finishes the surface target object.

The wheel assembly 30 includes a housing 31 in which a rotating wheel 32 is positioned. The wheel 32 includes a plurality of blades or vanes 33 that radially extend from a center axis 34, and the motor 40 rotates the wheel 32 about the center axis 34. In operation, the media is received into the wheel assembly 30 from the feed assembly 20. The media is accelerated by an impeller, then passes through a control cage (not depicted) that receives and dispenses the media via an opening (not depicted) toward the vanes 33. The media is dispensed onto the vanes 33, and rotation of the wheel 32 about the center axis 34 causes the vanes 33 to propel/accelerate the media in a radially outward direction toward the target object (e.g., the media is propelled along the radial length of the vanes 33 toward the target object). As such, the fast-traveling media contacts the target object thereby modifying or finishing the surface thereof.

The target object can be located in the housing 31 or in a media containment container (not depicted) adjacent to the housing 31. Note in certain examples, the media may travel through an outlet of the housing 31 before contacting the target object. In certain examples, the media is recycled back through the feed assembly 20.

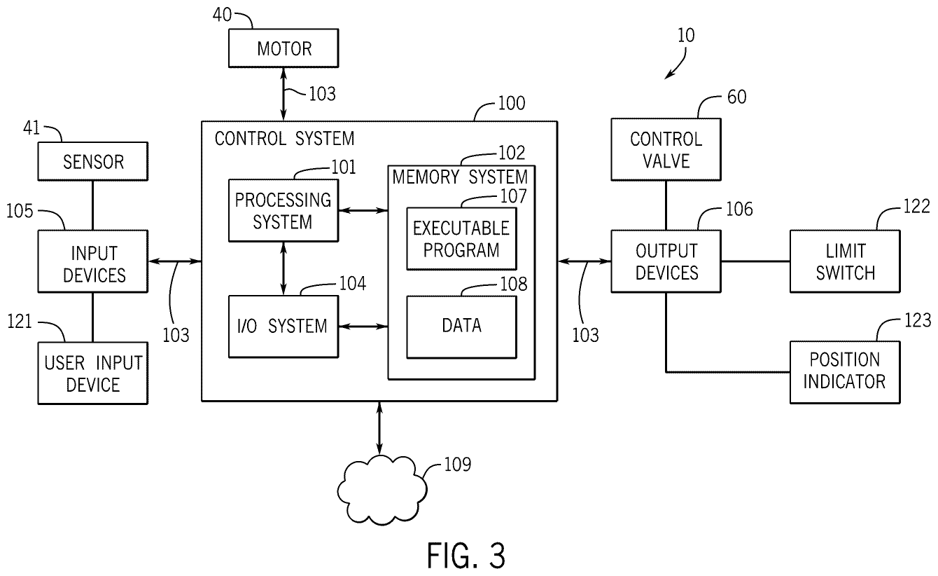

The system 10 includes a motor 40 that rotates the wheel 32. The motor 40 can include and/or is controlled by any suitable drive, such as a variable frequency drive, that is preferably capable of changing the speed at which the motor 40 operates. In one example, a variable frequency drive is configured to receive signals from a control system 100 (FIG. 3) to decrease the speed of the motor 40 as the volume and/or flow rate of the media propelled by the wheel 32 changes (example of which are described herein). Note that some conventional systems vary wheel revolutions per minute (RPM) based on the parts being finished or cycles of the blasting program, and the motor 40 of the present disclosure can be configured to rotate at a constant or fixed wheel RPM during operation of the system 10. The motor 40 is electrically coupled to the control system 100 (FIG. 3), and the motor 40 is configured to receive control signals from the control system 100 to thereby change operation of the motor 40. The motor 40 is also configured to send signals (e.g., feedback signals) to the control system 100 that correspond to the operation of the motor 40 such as actual/sensed amperage, speed, and the like. In other examples, the system 10 includes a sensor 41 (FIG. 3) configured to determine the sensed amperage of the motor 40 during operation. Reference is made to the above-incorporated U.S. Patents for other example shot peening or shot blasting systems having features or components that may be incorporated into the system 10 of the present disclosure.

The system 10 also includes a valve assembly 50 configured to control flow of the media flowing through the feed assembly 20. Generally, the valve assembly 50 has an inlet end 51 configured to receive the media (see arrow M) from a media source (not depicted; e.g., media hopper). An operable media valve 52 is configured to meter or control the volume and the flow rate of the media to the wheel 32, and an outlet end 53 is coupled to the tube 21 of the feed assembly 20.

The media valve 52 can be any suitable valve, such as a pneumatically actuated rotary or slide valve, configured to move to one, multiple, or variable open positions in which the media valve 52 is open and the media flows therethrough and alternatively to move to a closed position in which the media valve 52 is closed and the media does not flow therethrough. In one non-limiting example, the media valve 52 is actuated with a double-acting pneumatic cylinder constrained by stop bolts. The media valve 52 is configured to efficiently dispense the media and thus, a desired or optimum amount of media is conveyed to the wheel 32 which may be operating at a constant or fixed RPM. In certain examples, the stop bolts set the operational limits of the media valve 52 and thereby flow rate limits (e.g., 350 pounds per minute) of the media.

The valve assembly 50 has an actuator 55 that actuates/operates the media valve 52 (e.g., opens or closes the media valve 52, moves the media valve 52 to different open positions or to the closed position). The actuator 55 can be any suitable actuator such as a quarter-turn actuator (e.g., quarter-turn actuator commercially available from Festo part no. 804762), a spring return actuator, an air return actuator, a servomotor, stepper motor, a hydraulic actuator, a pneumatic actuator, a linear air cylinder with a slide valve, a linear air cylinder with a lever, and/or the like.

In one non-limiting example, the actuator 55 selectively receives pressurized air via an inlet port 56 and selectively exhausts or discharges pressurized air via an outlet port 57. Air hoses 58 are coupled to the ports 56, 57. The air hoses 58 are coupled to a control valve 60 that controls the flow of pressurized materials (e.g., pressurized air, pressurized hydraulic fluid) to the actuator 55 thereby operating and controlling the actuator 55 and the media valve 52. An input hose 59 supplies the pressurized material to the control valve 60 from a pressurized air or fluid source (e.g., air tank, air compressor, hydraulic system). The control valve 60 can be any suitable valve such as a proportional control valve (e.g., piezo valve), an air or fluid regulator, a proportional control valve (e.g., a proportional control valve commercially available from Festo part no. 8046300), and/or the like.

The control valve 60 is coupled to and in communication with a control system 100. The control system 100 is configured to send signals to the control valve 60 to thereby control the media valve 52 and flow rate of the media (as noted above). FIG. 3 depicts an example control system 100 according to the present disclosure. The control system 100 is configured to communicate with one or more components of the system 10 via communication links 103, which can be any wired or wireless links. The control system 100 is capable of receiving information and/or controlling one or more operational characteristics of the system 10 and its various sub-systems by sending and receiving control signals via the communication links 103. In one example, the communication link 103 is an analog signal; however, other types of links such as modbus or controller area network (CAN) bus could be used. It will be recognized that the extent of connections and the communication links 103 may in fact be one or more shared connections, or links, among some or all of the components in the system 10. Moreover, the communication link 103 lines are meant only to demonstrate that the various control elements are capable of communicating with one another, and do not represent actual wiring connections between the various elements, nor do they represent the only paths of communication between the elements. Additionally, the system 10 may incorporate various types of communication devices and systems, and thus the illustrated communication links 103 may in fact represent various different types of wireless and/or wired data communication systems.

The control system 100 may be a computing system that includes a processing system 101, memory system 102, and input/output (I/O) system 104 for communicating with other devices, such as input devices 105 and output devices 106, either of which may also or alternatively be stored in a cloud 109. The processing system 101 loads and executes an executable program 107 from the memory system 102, accesses data 108 stored within the memory system 102, and directs the system 10 to operate as described above and in further detail below.

The processing system 101 may be implemented as a single microprocessor or other circuitry, or be distributed across multiple processing devices or sub-systems that cooperate to execute the executable program 107 from the memory system 102. Non-limiting examples of the processing system include general purpose central processing units, programmable logic controllers, application-specific processors, and/or logic devices.

The memory system 102 may comprise any storage media readable by the processing system 101 and capable of storing the executable program 107 and/or data 108. The memory system 102 may be implemented as a single storage device, or be distributed across multiple storage devices or sub-systems that cooperate to store computer readable instructions, data structures, program modules, or other data. The memory system 102 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

The systems 10 of the present disclosure advantageously increase the efficiency of the system 10 and/or the motor 40 by at least in part optimizing the flow of media through the system 10. The systems 10 are further configured to reduce and/or minimize conventional problems associated with the centrifugal media propelling processes (e.g., shot peening or shot blasting process) and maintenance thereof.

During use of the system 10, the operator of the system 10 may wish to increase or decrease the volume or flow rate of the media passing to the wheel assembly 30 for a variety of reasons. For example, the system 10 is being utilized to finish a different part/component, the media in the system 10 may break down over time and continued use, bulk additions of media are added to the system 10, contaminants are included with the media, and/or parts of the system 10 wear down (e.g., the vanes 33 wear down). However, when changing the volume or flow rate of the media, operational characteristics of the motor 40 may also change. For example, the amperage of the motor increases or decreases as volume or flow rate of the media increases or decreases. For example, decreasing the volume or flow rate of the media to the wheel 32 and the vanes 33 decreases the amperage of the motor 40. In another example, increasing the volume or flow rate of the media to the wheel 32 and the vanes 33 increases the amperage of the motor 40.

The present inventors have observed that the motor is ideally operated at a full/max amperage and it would be advantageous to operate the motor at the full/max amperage as the amount of media changes to thereby the efficiency of the motor, reduce incidents of exceeding full/max amperage, and/or increase life of the motor. In one instance, if the motor is first operated at a low speed (e.g., less than full/maximum speed) and full/max amperage and subsequently operated at higher speed (e.g., full/maximum speed) without changing the volume or flow rate of media to the wheel and vanes (e.g., the volume or flow rate could be reduced by adjusting the stop blots of the media valve), the amperage of the motor 40 may increase above the full/max amperage thereby increasing the risk that the motor 40 will be damaged (e.g., motor burn out) due to operating above its full/max amperage.

As such, the systems 10 of the present disclosure address these problems and advantageously via the media valve 52 change the volume or flow rate of the media to the wheel 32 and the vanes 33 to avoid damaging the motor 40 and maintain efficient operation of the system 10. In one non-limiting example, the system 10 is configured to adjust the flow rate of the media with the media valve 52 to thereby maintain an optimum flow of the media to the wheel 32 such that the motor 40 operates at a desired target amperage. The target amperage can be any value or range (e.g., 22.5 amps or 15-16 amps) set by the operator and stored on the system 10, and in certain examples, the target amperage is the full/maximum allowable amperage of the motor 40 (as specified by the manufacturer of the motor 40). In certain examples, the motor 40 rotates the wheel 23 at a fixed RPM such that the system 10 controls the volume or flow rate of the media to the wheel to maintain the target amperage.

In one non-limiting example, the operator can change the speed of and flow rate to the wheel 32 by stopping the wheel 32, changing the drive target speed of motor 40, and further manually adjusting the stop bolts of the media valve 52. Adjusting the stop bolts changes the volume or flow rate of the media propelled by the wheel 32 and the vanes 33. Failure to adjust the media valve 52 would result in inefficient cycles and/or damage to the motor 40. In other examples, the operator may also change the volume and/or the flow rate of the media to the wheel 32 by inputting data/inputs into the system 10 via the input device 105 such that the control system 100 (FIG. 3) opens or closes the media valve 52. The operator changes the speed of the wheel 32 by inputting data/inputs into the system 10 via an input device 105. The control system 100 (FIG. 3) then changes or adjusts the speed of the motor 40 to thereby the speed of the wheel 32.

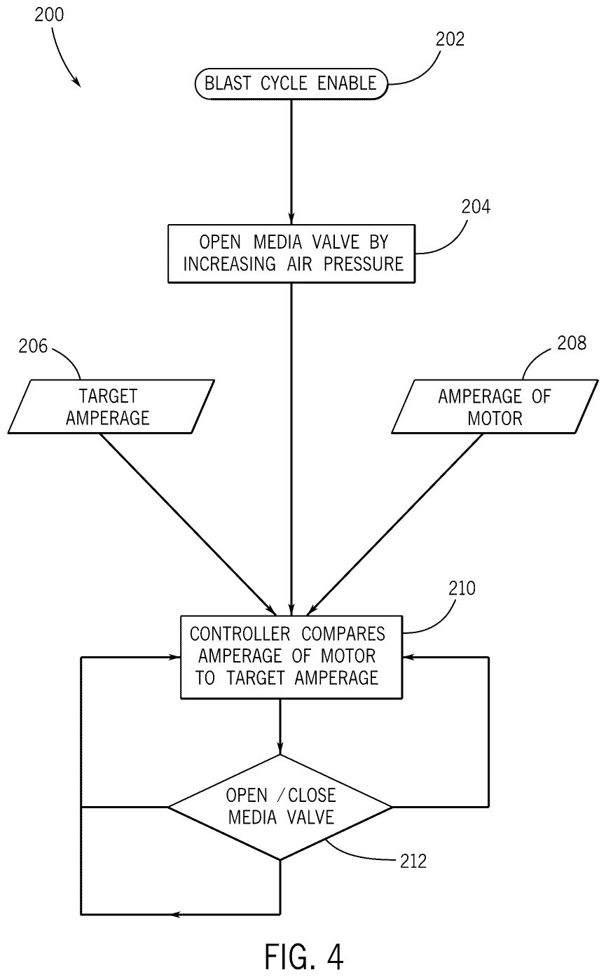

Referring now to FIG. 4, an example process flow 200 for operating the system 10 is described hereinbelow. The example process flow 200 depicted in FIG. 4 is for controlling the media valve 52 to thereby control the volume and/or flow rate of the media to the wheel 32 (see FIG. 2). The process flow 200 begins (at step 202) with the operator enabling or initiating the operation cycle by entering corresponding inputs into an input device 105, such as a human-machine interface or an user input device 121 (e.g., a potentiometer, touchscreen panel, personal computer). Enabling the operation cycle includes the control system 100 sending an initiation signal to the motor 40. The motor 40 begins operating at an initial motor RPM, hertz, and/or target amperage and rotates the wheel 32 at a first predetermined wheel speed.

The initial motor RPM, hertz, and/or target amperage of the motor 40, and/or the first predetermined speed of the wheel 32 are stored in the memory system 102 and/or inputted by the operator into the system 10 via the user input device 121. In other examples, the initial target amperage and/or the first predetermined wheel speed may be determined by the control system 100 based on a lookup table stored in the memory system 102. The lookup table can include motor, RPM, hertz, and/or target amperage values and/or the first predetermined wheel speed and motor amperage values that correspond to various factors such as type of media used, size of media, type of target object to be used, desired media pace/speed, peening or blasting level (low, medium, high), desired intensity, coverage percentage, and the like.

With the operation cycle enabled, the control system 100 sends signals to the output device(s) 106, such as the control valve 60, to vary fluid pressure to the actuator 55 which controls the position of the media valve 52 and flow rate of media passing through the media valve 52 (as described above) at step 204. For example, the control system 100 sends signals to the control valve 60 to actuate the actuator 55 such that the media valve 52 moves from a closed position (in which media does not flow to the wheel 32) to an initial open position. In the initial open position, the media valve 52 permits a volume and/or flow rate of media to pass to the wheel 32.

In certain examples, the pressure necessary to move the media valve 52 to the initial open position may be predetermined by the operator based on testing and stored on the memory system 102 and/or input into the control system 100 when the operator enables the operation cycle at step 202. In other examples, the fluid pressure required to reach the initial open position may be determined by the control system 100 from a look-up table based on the initial motor RPM, hertz, or amperage of the motor 40.

In still other examples, the initial open position is determined by the control system 100 by comparing values related to the pressure of air or fluid to the control valve 60 and the sensed amperage of the motor 40 to a look-up table. In this example, the control system 100 may as part of a continuous feedback loop or proportional-integral-derivative (PID) loop, adjusts the pressure delivered to the actuator 55 to move the media valve 52 into the initial open position and/or based on the sensed amperage of the motor 40.

With the motor rotating the wheel 32 and the media valve 52 open, the media is propelled by the wheel 32 (as noted above). As such, the media contacts the wheel 32 and increases the amperage of the motor 40. Generally, increases in media flow to the wheel 32 results in an increase in the amperage of the motor 40. The motor 40 and/or the current meter or sensor 41 coupled to the motor 40 sends signals to the control system 100 that correspond to the value of the sensed amperage (see step 208). In addition, a target amperage (see step 206), is stored on the memory system 102 and/or input in the control system 100 by the operator when the operation cycle is enabled (at step 202).

At step 210 the control system 100 determines if the target amperage value equals the measured motor amperage value. For example, the processing system 101 compares the sensed amperage to the target amperage. If the control system 100 determines that the amperage of the motor is equal to the target amperage, the control system 100 maintains or does not send signals to the change operation of the control valve 60. As such, the media valve 52 remains in its current position. In one example, the control system 100 may send signals to the control valve 60 to hold the pressure steady or constant such that the media valve 52 maintains the current position.

However, if the control system 100 determines that the amperage of the motor is less than or greater than the target amperage, the control system 100 is configured to send control signals to the control valve 60 to thereby actuate the actuator 55 and adjust the position of the open media valve 52 at step 212. Accordingly, the media valve 52 may move to a new position that either increases the flow of the media to the wheel 32 to thereby increase the load on the wheel 32 and the amperage of the motor 40 or decrease the flow of the media to the wheel 32 to thereby decrease the load on the wheel 32 and the amperage of the motor 40. For example, the control system 100 sends control signals to the control valve 60 to increase pressure to the actuator 55 to further open the media valve 52 thereby increasing the volume or flow rate of the media and increasing the amperage of the motor 40. In another example, the control system 100 sends control signals to the control valve 60 to decrease pressure to the actuator 55 to close the media valve 52 thereby decreasing the volume or flow rate of the media and decreasing the amperage of the motor 40.

In one non-limiting example, a 7.50 hp motor operating at 3600.0 RRM has a target amperage of 8.40 amps. In operation, the actuator 55 is sent 45.0 pound per square inch (psi) of air pressure to thereby open the media valve 52 such that an ideal flow of media causes the motor 40 to operate with an amperage of 8.20 amps +/−0.05 amp variation throughout the cycle. The control system 100 is configured to continuously receive signals from the motor 40 and/or current meter or sensor 41 such that that control system 100 continuously monitors the amperage of the motor 40 and accordingly makes necessary modifications to the pressure to the actuator 55 to change position of the media valve 52 (e.g., the current sensor 41, the actuator 55, and/or the control system 100 are part of a continuous feedback loop or proportional-integral-derivative (PID) loop or nested feedback loops or proportional-integral-derivative (PID) loops).

In another non-limiting example, the control valve 60 is capable of precisely and continuously controlling the actuator 55 to thereby change the position of the media valve 52 (e.g., open or close the media valve 52). As such, the control valve 60 controls the motor amperage (via the actuator 55 and the media valve 52) +/−0.05 amps relative to a setpoint of 10.0 amps.

In one example, the control valve 60 is a proportional control valve (e.g., piezo valve). Note that the proportional control valve may be devoid of wearable components. The proportional control valve receives the pressurized air and dispenses the pressurized air to an example actuator 55 with return springs (e.g., compression springs) configured to bias the media valve 52 to a closed position in which the media valve 52 is closed and the media does not flow to therethrough. The pressure of the air compresses the return springs such that the media valve 52 moves/opens. That is, as pressure to the actuator 55 increases, the return springs compress and the media valve 52 opens and/or moves into different open positions. Similarly, as pressure to the actuator 55 decreases, the return springs decompress and the media valve 52 closes and/or moves to one of the open positions or the closed position. Note that in the event pressure to the actuator 55 stops (e.g., pressure is zero), the actuator 55 moves the media valve 52 to the closed position such that media does not flow (e.g., the actuator 55 acts as a fail-safe shutoff device in the event pressurized air to the system 10 is lost). In certain examples, a solenoid valve (not depicted) is included with the valve assembly 50 to thereby assist with closing the media valve 52 in the event pressure to the actuator 55 decreases to zero. In this example, the solenoid valve acts as a fail-safe in the event of pressure loss.

In certain examples, the system 10 includes a limit switch or limit switch box 122 (e.g., limit switch box manufactured by Festo part no. SRBI-C2-N-1-P-M12) or an encoder device that is configured to verify proper operation of the system 10 by sending signals to the control system 100 corresponding to situations when the media valve 52 is fully open, the incoming flow of media stops, and/or the media valve 52 is fully closed to verify proper operation of the system. The signals from the limit switch 122 are further utilized by the control system 100 to generate alarms (e.g., graphical alarms on a display screen or audible alarms) when the media valve 52 is in an unexpected position. In certain examples, the signals from the limit switch 122 are utilized by the control system 100 to determine positional feedback information related to the media valve 52 via feedback loops and/or nested feedback loops. In one instance, the feedback information includes a feedback loop that monitors position of the media valve 52 and/or a feedback loop that monitors amperage of the motor 40 and sends a target position of the media valve 52 rather than an actual pressure value.

In certain examples, the output devices 106 comprise a position indicator (e.g., position indicator manufactured by Festo part no. SASF-S3-B-F-A20) that is configured to visually or audibly indicate the position of the media valve 52 to the operator. Note that the position indicator may also be configured to send position signals to the control system 100 to thereby verify or “double check” that the actual position of the media valve 52 corresponds to the expected position of the media valve 52 moved to by the control system 100. The position indicator can also be utilized to activate the limit switch or limit switch box 122. In other examples, one or multiple emergency shutoff valve (e.g., solenoid valves 301 and 302) are used as an emergency stop to prevent pressurized air or fluid from entering the open pressure side control valve 60 while simultaneously pressurizing the exhaust side of the control valve 60 in the event the control system 100 determines or senses failure of the components of the system 10.

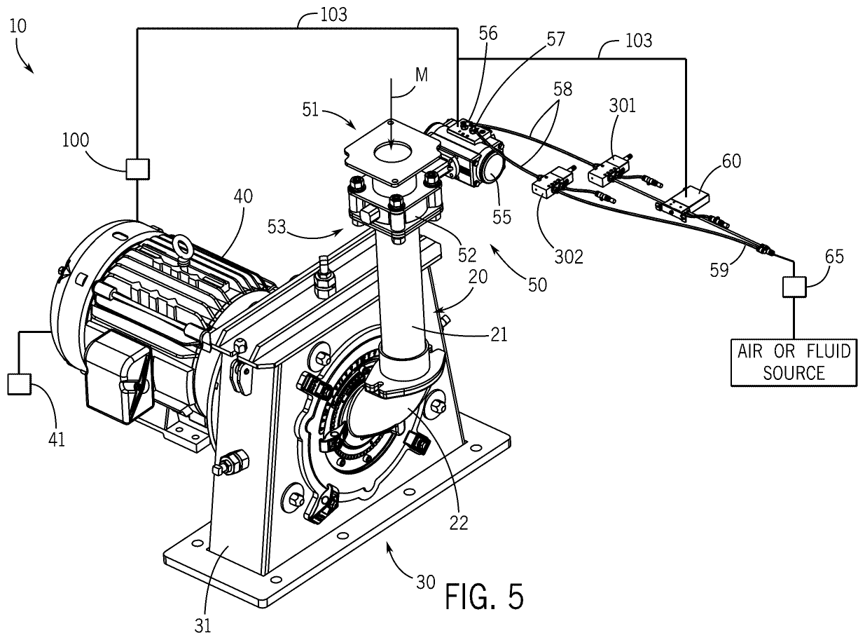

FIG. 5 is a perspective view of another example system 10. The features and/or components of the example system 10 described above with respect to FIGS. 1-4 can be incorporated into the example system 10 depicted in FIG. 5 and the features and/or components of the system 10 depicted in FIG. 5 can be incorporated into the example systems 10 described above with respect to FIGS. 1-4.

The system 10 depicted in FIG. 5 includes a 3/2 normally open valve 302 coupled between the control valve 60 and the inlet port 56 and 3/2 normally closed valve 301 coupled to and between the control valve 60 and the outlet port 57. The valves 301, 302 are configured to ensure that the control valve 60 is forced to close in the event of total power and/or pressure loss. Without being actuated, the normally open valve 302 would simply dump any residual pressure in the system 10 to atmosphere. The normally closed valve 301 forces pressure into the outlet port 57, forcing a full close. In operation, both valves 301, 302 are actuated thereby allowing free passage of air pressure between the control valve 60 and the inlet port 56 as well as the outlet port 57 for passage of air to atmosphere. In one example, the valves 301, 302 are solenoid valves.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A media propelling system comprising:
a motor for rotating a wheel assembly that is configured to propel the media;
a valve assembly configured to control flow rate of the media to the wheel assembly, the valve assembly comprises:
a media valve configured to selectively open and close to control the flow rate of the media to the wheel assembly;
an actuator that actuates the media valve to open or close the media valve and thereby change the flow rate of the media;
a control valve configured to receive pressurized material and dispense the pressurized material to the actuator to thereby control operation of the actuator; and
a control system in communication with the motor and the control valve and being configured to control the control valve based on a comparison of a sensed or actual amperage of the motor and a target amperage of the motor.

2. The media propelling system according to claim 1, wherein if the control system determines that the sensed or actual amperage of the motor is less than or greater than the target amperage, the control system is configured to control the control valve to actuate the actuator such that the media valve opens or closes.

3. The media propelling system according to claim 2, wherein the media valve opens such that the flow rate of the media to the wheel assembly increases thereby increasing the sensed or actual amperage of the motor, and wherein the media valve closes such that the flow rate of the media to the wheel assembly decreases thereby decreasing the sensed or actual amperage of the motor.

4. The media propelling system according to claim 1, wherein the control system is configured to continuously compare the sensed or actual amperage of the motor to the target amperage.

5. The media propelling system according to claim 1, wherein the actuator has a return spring configured to bias the media valve to a closed position, and wherein in the absence of pressurized material received by the actuator, the return spring causes the actuator to close the media valve.

6. The media propelling system according to claim 1, wherein the control valve is a proportional control valve.

7. The media propelling system according to claim 1, further comprising a sensor configured to sense the amperage of the motor and determine the sensed amperage of the motor.

8. The media propelling system according to claim 1, wherein the pressurized material is pressurized air.

9. The media propelling system according to claim 1, wherein the actuator is a variable pressure fluid operated spring return actuator.

10. A method of operating a media propelling system, the method comprising:
operating a motor for rotating a wheel assembly that is configured to propel the media;
providing a media valve that is configured to selectively opens or closes to thereby vary flow of the media to the wheel assembly;
comparing, with a control system, sensed or actual amperage of the motor to a target amperage of the motor;
controlling, with the control system, pressure of pressurized material dispensed from a control valve to an actuator to thereby control operation of the actuator which opens or closes the media valve.

11. The method according to claim 10, further comprising changing the pressure of the pressurized material until the sensed or actual amperage of the motor matches the target amperage of the motor.

12. The method according to claim 10, wherein if the control system determines that the sensed or actual amperage of the motor is less than the target amperage, the control system opens the media valve to increase flow rate of the media and increase the sensed or actual amperage of the motor; and
wherein if the control system determines that the sensed or actual amperage of the motor is greater than the target amperage, the control system closes the media valve to decrease the flow rate of the media and decrease the sensed or actual amperage of the motor.

13. The method according to claim 10, wherein the control system is configured to continuously compare the amperage of the motor to the target amperage of the motor.

14. The method according to claim 10, further comprising biasing, with the actuator, the media valve to a closed position such that in the absence of pressure of the pressurized material at the actuator, the actuator is configured to close the media valve.

15. The method according to claim 14, wherein the actuator is a variable pressure fluid operated spring return actuator.

16. The method according to claim 14, wherein the control valve is a proportional control valve.

17. The method according to claim 14, further comprising sensing, with a sensor, the amperage of the motor.

18. The method according to claim 14, wherein the pressurized material is pressurized air.
